(19) United States
(12) Patent Application Publication
(10) Pub. No.: US 2013/0037323 A1
(43) Pub. Date: Feb. 14, 2013

(54) ELECTROLUMINESCENT SYSTEMS

(71) Applicants: Jaime Smith, Wilsonville, OR (US); Mieszko Kruger, Lake Oswego, OR (US)

(72) Inventors: Jaime Smith, Wilsonville, OR (US); Mieszko Kruger, Lake Oswego, OR (US)

(21) Appl. No.: 13/209,237

(22) Filed: Aug. 12, 2011

(51) Int. Cl. H02G 15/02; H01B 7/00

(52) U.S. Cl. 174/75 R; 174/70 R; 174/110 R

(57) ABSTRACT

This application pertains to electroluminescent systems, and more particularly, but not exclusively, to innovative configurations of EL-wires and EL-cables. A central axis can extend longitudinally of an EL-cable: An electrically conductive core defines a longitudinal axis being substantially coextensive with the central axis of the cable. An electroluminescent material electrically couples to the core. A first electrical conductor is outwardly spaced from the core and electrically coupled to the electroluminescent material such that an AC-voltage potential applied between the core and the first electrical conductor induces the electroluminescent material to luminesce, defining a luminescent region of the cable. A second electrical conductor is outwardly spaced from and helically overlies the core. The second electrical conductor is substantially electrically isolated from the electroluminescent material. An insulation layer overlies the second electrical conductor and at least a portion of the luminescent region of the cable.

### BACKGROUND

This application generally pertains to electroluminescent wires and electroluminescent cables (sometimes referred to as “EL-wires” and “EL-cables,” respectively). A typical electroluminescent wire has an electrically conductive core coated with an electroluminescent material (e.g. a phosphor) and one or more electrical conductors surrounding (e.g., helically wrapped around) the coated core and electrically coupled to the electroluminescent material. An optically transmissive coating can overlie the electroluminescent material and helically wrapped conductor, insulating the assembly. An excitation signal (e.g., a high-voltage alternating current) can be applied between the core and the helically wrapped conductor(s), inducing an electrical current to pass through the electroluminescent coating, thereby exciting the luminous coating to emit light.

As used herein, a “wire” means an apparatus having a single electrical conductor, e.g., a solid electrical conductor or a stranded electrical conductor. Usually, but not always, a wire also has an insulator at least partially enveloping the conductor. A solid electrical conductor has a unitary construction; thus, a wire comprising a solid electrical conductor generally resembles a rod having a long, narrow profile. A stranded electrical conductor comprises a plurality of solid electrical conductors positioned adjacent and electrically coupled to each other, forming a single electrical conductor. In some instances, a stranded electrical conductor can be described as comprising a bundle of solid electrical conductors forming a single electrical conductor.

As used herein, a “cable” means an apparatus having a plurality of independent electrical conductors, e.g., two or more wires (e.g., insulated wires) positioned within a common outer sheath.

As used herein, “electroluminescent” means a quality of emitting light in response to the presence of an electric current or in the presence of a magnetic field. Thus, an “electroluminescent material” means a material that emits light in response to an electric current passing through the material, or in response to exposure to a magnetic field.

As used herein, an “electroluminescent wire” means any of a variety of wire constructs comprising an electroluminescent material and being configured to pass an electrical current through the electroluminescent material, or to expose the electroluminescent material to a magnetic field, and, thereby, to cause the electroluminescent material to emit light.

As used herein, an “electroluminescent cable” means a cable construct comprising an electroluminescent wire.

Previously proposed illuminable devices have suffered from one or more serious deficiencies. As a result, previous illuminable devices have met with limited success in the marketplace.

For example, U.S. Pat. No. 6,945,663 (Chien), which is hereby incorporated in its entirety, discloses an EL-wire wrapped around a conductor, giving Chien's device the appearance of a luminescent helix. The tubular structure described in Chien is stiff, difficult to build, and expensive. Moreover, its luminescent helix gives Chien's device the appearance of being only partially lit, since the conductor extending within the helix partially obscures the luminescent EL-wire helix.

U.S. Pat. No. 7,561,060 (Duffy), which is hereby incorporated in its entirety, discloses a data cable having an electroluminescent strand routed along (understood to mean parallel to) the data cable and being configured to illuminate in response to a predetermined condition. For example, Duffy's data cable can provide a user with a visual cue indicating that a fault occurred in a computer system.

U.S. Publication No. 2007/0019821 (Dudley), which is hereby incorporated in its entirety, discloses a personal headphone designed to be used with a personal music player and having an EL-wire paired with a copper conductor to give the appearance that the headphone wires are glowing. However, Dudley does not describe any particular configuration for such pairing of the EL-wire and conductor. Dudley describes a control box that mounts to the personal music player. The control box has four main functions: (1) to provide power to the EL-wire (e.g., from two AAA or AA alkaline batteries), as not to drain power from the player's batteries; (2) to “pick up current spikes which would indicate the beat of the music and may be used to pulse the light to the music”; (3) to mute the music; and (4) to switch colors or alternate colors for the multi-color unit.

U.S. Publication No. 2011/0103607 (Bychkov), which is hereby incorporated in its entirety, discloses luminescent headphones without battery packs. Specifically, Bychkov discloses headphones having an audio wire alongside or coiled around a “light pipe” (understood to be an optical conductor, e.g., an optical fiber) illuminated by a light-emitting diode (LED) or other light source. Bychkov also discourages using an EL-wire to illuminate, for example, earphone wires because previously known EL-wire devices (e.g., Dudley) rely on external battery packs for powering the EL-wire, making prior EL-wire devices cumbersome and, at least in the case of earphones, uncomfortable for the user. Bychkov also emphasizes that at least some previous earphones having an EL-wire use a transformer to convert a battery voltage to a high-voltage for activating the EL-wire, stating that “transformers often cause a humming noise, which interferes with the audio experience.” Bychkov does not provide for or even suggest an approach for eliminating such “humming”, other than to abandon EL-wire and EL-cable constructs altogether.

Light pipes generally emit light non-uniformly. For example, a light-pipe will often be brighter closer to the source than farther from the source, gradually fading with distance from the source. In Bychkov's device, an LED would normally need to be driven strongly, requiring relatively high electrical currents and heat dissipation.

Additionally, known EL-wires have a single illuminable segment.

Accordingly, there remains a need for a cable having an EL-wire and one or more electrical conductors, appearing to be continuously, or substantially continuously, and uniformly (rather than merely partially) illuminated. There also generally remains a need for an EL-wire to have a plurality of illuminable segments, and, more particularly, but not exclusively, a need for each of the illuminable segments to be illuminable independently of (or out-of-phase with) at least one other of the illuminable segments. As well, a need for parasitic EL-wire devices remains. EL-wire devices configured to eliminate, suppress, or mitigate noise caused by a transformer are also needed.

As used herein, a “parasitic device” means a device configured to receive electrical power from another electrical device's power source, rather than its own power source.

### SUMMARY

The innovations disclosed herein overcome many problems in the prior art and address one or more of the aforementioned, as well as other, needs. The innovations disclosed herein pertain generally to electroluminescent devices and related systems, and more particularly, but not exclusively, to innovative configurations of EL-wires and EL-cables, as well as useful devices incorporating one or more of an EL-wire and an EL-cable. EL-wires and EL-cables generally offer an aesthetic quality that was previously unavailable using conventional wires and cables.

Although many configurations of EL-wires and EL-cables can be developed from one or more innovative principles described below, specific embodiments of EL-wires and EL-cables (e.g., data cables configured to carry a data signal from one computing device to another computing device or peripheral device; headphones; device charging cables) are described below as a means of illustrating the innovative principles, rather than identifying all possible configurations of EL-wires and EL-cables.

For example, some innovations are directed to a configuration of an EL-cable having one or more electrical conductors for conveying an electrical signal and/or an electrical current. Other innovations are directed EL-wires having a plurality of illuminable segments (e.g., that can illuminated at different times and/or independently of each other). Still other innovations are directed to cables incorporating an EL-wire and being configured to operatively couple an electrical device to another electrical device. In some instances, such an EL-cable is configured as a parasitic EL-cable. And, other disclosed innovations are directed to devices having an EL-wire and being configured to eliminate, suppress, or mitigate noise caused by a transformer powering the EL-wire.

In some examples, luminescent cables are described. A central axis extends longitudinally of the cable: An electrically conductive core defines a longitudinal axis being substantially coextensive with the central axis of the cable and has an outwardly facing outer surface. An electroluminescent material electrically couples to a portion of the outer surface of the core. A first electrical conductor is outwardly spaced from the core and electrically coupled to the electroluminescent material such that an AC-voltage potential applied between the core and the first electrical conductor induces the electroluminescent material to luminesce, defining a luminescent region of the cable. A second electrical conductor is outwardly spaced from and helically overlying the core. The second electrical conductor is substantially electrically isolated from the electroluminescent material. An insulation layer overlies the second electrical conductor and at least a portion of the luminescent region of the cable.

Other luminescent apparatus are also described. An electroluminescent wire can be configured to luminesce in response to an AC voltage potential applied to an electroluminescent wire. The apparatus can include a signal conductor and a ground conductor, and a noise suppression circuit configured to suppress noise within a data signal carried by the signal conductor caused, at least in part, by an alternating current induced by the AC voltage potential.

Examples of electroluminescent cables are described. An electroluminescent cable can have an electroluminescent wire configured to luminesce in response to an AC voltage applied between a first power conductor and a second power conductor. The cable can include an electrical connector having a plurality of electrical couplers. The electrical connector can be configured to matingly engage with a correspondingly configured electrical connector of an electrical device, and, thereby, to electrically couple at least one of the electrical couplers to a DC power circuit of the electrical device. The EL-cable can also include a housing. A power circuit can be positioned within the housing and so operatively coupled to the at least one of the electrical couplers as to be configured to receive an electrical current from the DC power circuit of the electrical device. The power circuit can also be so operatively coupled to the first power conductor and to the second power conductor as to deliver an AC voltage potential between the first power conductor and the second power conductor based on power derived from the DC

In some specific embodiments, electroluminescent audio cables are disclosed. For example, such an audio cable can include an electroluminescent wire configured to luminesce in response to an AC voltage applied between a first power conductor and a second power conductor. A first signal conductor and a second signal conductor can be positioned adjacent to each other in a first segment of the audio cable and the first signal conductor and the second signal conductor can be spaced from each other in a second segment of the audio cable. A splitter housing can be positioned between the first segment of the audio cable and the second segment of the audio cable, so that the first signal conductor extends from the splitter housing in a first direction and the second signal conductor extends from the splitter housing generally in a second direction opposite the first direction. A power circuit can be positioned within the splitter housing and so operatively coupled to the first power conductor and the second power conductor as to deliver an AC voltage potential between the first power conductor and the second The foregoing and other features and advantages will become more apparent from the following detailed description, which proceeds with reference to the accompanying drawings.

### BRIEF DESCRIPTION OF THE DRAWINGS

Unless specified otherwise, the accompanying drawings illustrate aspects of the innovative subject matter described herein. Referring to the drawings, several aspects of the presently disclosed principles are illustrated by way of example, and not by way of limitation, in detail in the drawings, wherein:

FIG. 1 illustrates an isometric view of a partial section of an electroluminescent data cable;

FIG. 2 illustrates an isometric view of a partial section of an electroluminescent cable showing a segmented electroluminescent material;

FIG. 3 illustrates an isometric view of audio headphones incorporating an electroluminescent data cable;

FIG. 3A shows an electroluminescent cable of the type illustrated in FIG. 3 operatively coupled with a commercially available smartphone;

FIG. 4 illustrates a schematic block diagram of the audio headphones shown in FIG. 3;

FIG. 5 illustrates an isometric view of an electroluminescent cable configured to operatively couple a first electrical device and a second electrical device to each other;

FIG. 5A shows an electroluminescent cable of the type illustrated in FIG. 5 operatively coupled with a commercially available smartphone;

FIG. 6 illustrates a schematic block diagram of the cable shown in FIG. 5;

FIG. 7 illustrates an isometric view of another embodiment of audio headphones incorporating an electroluminescent data cable;

FIG. 8 illustrates a schematic block diagram of the audio headphones shown in FIG. 7;

FIG. 9 schematically illustrates a split ground plane configured to diminish noise in an analog data signal induced by an AC potential applied across an electroluminescent material;

FIG. 10A shows a schematic block diagram of a static notch filter configured to filter one or more frequency bands from an audio signal. FIG. 10B shows an example of an electrical circuit configured to filter a selected frequency band from an audio signal. FIG. 10C shows another example of an electrical circuit (e.g., an op-amp circuit) configured to filter a selected frequency band from an audio signal;

FIG. 11A shows a schematic block diagram of a filter configured to cancel noise from an audio signal by subtracting a feed forward noise signal from the audio signal. FIG. 11B shows an example of an analog circuit configured to subtract a noise signal from an audio signal. FIG. 11C shows a schematic illustration of a digital signal processor configured to cancel noise from an audio signal;

FIG. 12 shows schematic block diagram of a digital signal processor configured as a band-stop filter; and

FIG. 13 shows a schematic block diagram of an adaptive filter configured to cancel noise from an audio signal by subtracting an observed noise signal from the audio signal.

### DETAILED DESCRIPTION

The following describes various innovative principles related to EL-wires, EL-cables, and related devices, by way of reference to specific examples. However, one or more of the disclosed principles can be incorporated in various device and system configurations to achieve any of a variety of corresponding characteristics. Particular configurations, applications, or uses, described below are merely examples of systems incorporating one or more of the innovative principles disclosed herein, and are used to illustrate one or more innovative aspects of the disclosed principles. Thus, devices and systems having attributes that are different from those specific examples discussed herein can embody one or more of the innovative principles, and can be used in applications not described herein in detail, for example, to illuminate an extension cord, a data cable (e.g., a USB, a micro-USB, or a printer cable), a power cord (e.g., for a computer, a charger cord for a mobile device), and an electrical wire within a wall of a building, as well as, among other applications, stereo audio cables, car chargers, Christmas (e.g., decorative) lights, bracelets, necklaces, shoe laces, clothing enhancement with power and sensor relay capabilities, antennas, and sailing rope and cabling.

Accordingly, such alternative embodiments also fall within the scope of this disclosure.

### Example of an Electroluminescent Cable

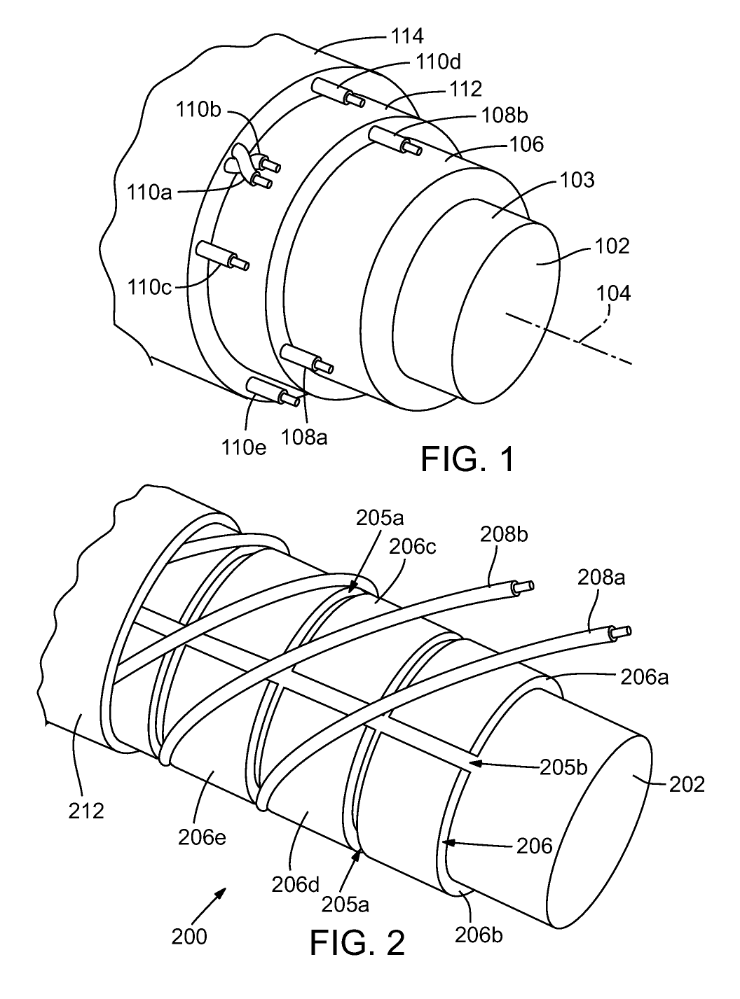

Referring to FIG. 1, an electroluminescent cable 100 having a central axis extending longitudinally of the cable can have a generally coaxial construction (e.g., a plurality of generally concentric constructs surrounding a core). In the illustrated cable 100, the core 102 is electrically conductive and defines a longitudinal axis 104 being substantially coextensive with the central axis of the cable and having an outwardly facing outer surface 103.

The core 102 can comprise a solid conductor or a stranded conductor. Generally, the core 102 represents the stiffest component of the illustrated EL-cable 100. Accordingly, reducing a cross-sectional area of the core 102 can decrease the EL-cable's stiffness, making the EL-cable 100 a desirable alternative to, for example, a light pipe, for illuminating a cable.

An electroluminescent material 106 overlies and electrically couples to the outer surface 103 of the core 102. The electroluminescent material 106 can comprise a phosphor compound, or another organic or inorganic electroluminescent material. The active compound(s) in an electroluminescent material are generally semiconductors having a sufficiently wide bandwidth to allow light emission. An example of a common inorganic thin-film electroluminescent (TFEL) compound is ZnS:Mn, having a yellow-orange emission. Other examples of electroluminescent compounds include powder zinc sulfide doped with copper and/or silver, thin film zinc sulfide doped with manganese, natural blue diamond (e.g., a diamond having a boron dopant). III-V semiconductors, with InP, GaAs, and GaN being examples, and inorganic semiconductors, such as, for example, [Ru(bpy)₃]²⁺(PF₆⁻)₂, where bpy is 2,2′-bipyridine.

One or more electrical conductors 108a, 108b are outwardly spaced from the core 102 and electrically coupled to the electroluminescent material 106. Each of the conductors 108a,b can comprise a solid conductor or a stranded conductor.

As indicated in FIG. 1, three electrical conductors 108a, 108b (and one not shown) can be circumferentially spaced apart by, for example, about 120-degrees and oriented substantially parallel to the core 102. In other embodiments (e.g., shown in FIG. 2), one or more of the electrical conductors can be helically wound around the electroluminescent material. In any event, an AC-voltage potential applied between the core 102 and the electrical conductor(s) 108a, 108b tends to induce an electric current to pass through the electroluminescent material 106 and cause it to emit light, defining a luminescent region of the cable 100.

The electroluminescent material 106 shown in FIG. 1 has a generally uniform composition in a longitudinal, a circumferential and a radial direction relative to the EL-cable 100. As well, a radial dimension (e.g., a thickness) of the electroluminescent layer 106 is generally uniform. With such a uniformly applied electroluminescent material, the EL-cable 100 can emit light having a generally uniform color and intensity along a longitudinal and a circumferential direction. Nonetheless, non-homogeneous material compositions, as well as non-uniform thickness coatings can be well-suited for some applications. FIG. 2 shows but one such example.

One or more other wires 110a, 110b, 110c, 110d, 110e are spaced from the core 102. Each respective electrical conductor in the group of wires 110a-e can be solid or stranded, and is electrically isolated from the other wires, as well as the electroluminescent material 106 and the electrical conductors 108a,b used to power the luminescent region of the cable 100. For example, each of the illustrated wires 110a-e has a respective insulation coating overlying the respective conductor. As well, each of the illustrated wires 110a-110e is spaced (e.g., circumferentially and outwardly) from the conductors 108a, 108b used to power the luminescent region.

The wires 110a-e can be configured for any of a variety of selected purposes. For example, the wires 110a-e can be configured to convey a selected electrical current and/or a selected electrical signal (e.g., digital or analog). In addition, the wires 110a-e can have any of a variety of physical configurations, for example, a twisted differential pair (e.g., wires 110a and 110b), a flex circuit or a flat wire. One or more of the “utility” wires (e.g., the wires 110a-e configured to carry power and/or a signal) can have a relatively smaller cross-sectional area than the core 102 and/or the generally annular coating of electroluminescent material 106 to reduce the degree to which the wires obscure light from the electroluminescent layer.

In the illustrated embodiment of the EL-cable 100, a sheath 112 is positioned between the wires 110a-e and the power conductors 108a,b. The sheath 112 can have insulating and/or shielding properties, as well as selected optical properties. For example, the sheath 112 can be an electrical insulator, a grounded electrical conductor, and/or an optically transparent or translucent layer.

Unlike a conventional EL-wire that merely illuminates, an EL-cable having a sheath 112 and/or a “utility” wire 110a-e provides additional functional capabilities lacking from previously known EL-wire devices. For example, the EL-cable 100 can carry power or electrical signals at a number of selected voltages (e.g., corresponding to each of one or more of the wires 110a-e). As well, circuits that include the wires 110a-e can be grounded separately from each other and/or separately from a circuit supplying power to the conductors 108a,b. As described more fully below with reference to FIG. 9, separate grounding can reduce the level of noise caused by electromagnetic interference from the high-frequency AC supplied to the conductors 108a,b and core 102 that otherwise would be introduced to a current or a signal carried by the wires 110a-e. In addition, the sheath 112 can be grounded and/or provide other shielding properties, further reducing electromagnetic interference from the high-frequency AC used to illuminate the electroluminescent material 106. In some instances, the sheath can be transmissive of light, such as, a clear, electrically conductive thin film, or a perforated metal mesh.

An outer insulation sheath 114 can circumferentially and longitudinally overlie the utility conductor 110a-e, power conductor 108a,b, sheath 112, electroluminescent layer 106, and core 102 of the cable 100. The outer sheath 114 generally protects the electrical conductors 108a,b and 110a-e from being damaged, as by chafing, and can maintain the generally coaxial assembly of the EL-cable 100 in a tightly bundled assembly.

Generally, the outer insulation sheath 114 is electrically non-conductive and can be optically transparent, translucent or opaque. A translucent or opaque sheath 114 tends to diffuse light emitted by the electroluminescent material 106 and tends to reduce the degree to which the wires 110a-e obscure the electroluminescent material from view.

The sheath 114 can have a number of configurations. For example, the insulation sheath 114 can have a generally uniform optical quality longitudinally and circumferentially of the EL-cable 100. Alternatively, the sheath 114 can have a plurality of longitudinal segments adjoining each other in end-to-end relation, with each of the longitudinal segments having a selected optical quality (e.g., a given segment can be transparent, translucent, or opaque, or have a selected color) that differs from an optical quality of another (e.g., an adjacent) segment. In some embodiments, the insulation sheath 114 can have a circumferentially varying optical quality, giving the EL-cable one appearance when viewed from a given direction and another appearance when viewed from a different direction.

Other configurations of an EL-cable are also possible. For example, the EL-cable shown in FIG. 1 has a solid core conductor 102. However, the core conductor 102 need not be solid, and can have a hollow central region defining a generally annular cross-section for the core. The wires 110a-e can be routed internally of such a hollow core, further reducing the degree to which the electroluminescent material is obscured from view. The sheath 112 can be positioned within the hollow central region and between the internally routed wires and an inner wall of the annular, hollow core, such that the wires 110a-e are inwardly spaced from the core, rather than outwardly spaced from the core, as shown in FIG. 1.

### Segmented Electroluminescent Material

FIG. 2 shows an alternative configuration for an electroluminescent material. Rather than a continuous and generally uniform layer of electroluminescent material 106 (FIG. 1), the EL-wire 200 shown in FIG. 2 has a segmented electroluminescent layer 206 defined by a plurality of spaced-apart electroluminescent segments 206a-e. Like the EL-cable 100, the EL-wire 200 has a conductive core 202 and overlying electrical conductors 208a, 208b, such that an AC potential applied between the core 202 and the conductors 208a,b will tend to illuminate the electroluminescent layer 206. A sheath 212 (shown as being partially cut away in FIG. 2 and being similar to the sheath 112 (FIG. 1)) overlies the electroluminescent layer 206 and conductors 208a,b, retaining the EL-wire components in a generally coaxial assembly.

As shown in FIG. 2, individual segments of the electroluminescent material 206a, 206b, 206c, 206d, 206e can be spaced apart in a longitudinal and a circumferential direction, defining circumferentially extending recesses 205a and longitudinally extending recesses 205b between adjacent segments.

In addition, each of the conductors 208a and 208b can form a helical coil overlying and electrically coupling to a respective plurality of the electroluminescent segments. For example, the conductor 208a overlies segments 206a and 206d, and the conductor 208b overlies segments 206c and 206e. An AC-voltage potential applied between the core 202 and the first electrical conductor 208a tends to induce the first plurality of segments 206a,d to emit light, defining a first luminescent region of the EL-wire 200. Similarly, since the conductor 208b overlies the second plurality of segments 206c,e, an AC-voltage potential applied between the core 202 and the second electrical conductor 208b tends to induce the segments 206c,e to emit light, defining a second luminescent region of the EL-wire 200.

The first electrical conductor 208a can be sufficiently electrically isolated from the second plurality of segments 206c,e that an AC voltage potential applied between the core 202 and the first electrical conductor does not induce the second plurality of segments to emit light. Similarly, the second electrical conductor 208b can be sufficiently electrically isolated from the first plurality of segments 206a,d that an AC voltage potential applied between the core 202 and the second electrical conductor does not induce the first plurality of segments to emit light.

In use, a frequency of the AC voltage potential applied between the core 202 and the first electrical conductor 208a can differ from (e.g., be out of phase with) a frequency of the AC voltage potential applied between the core and the second electrical conductor 208b. With such a configuration, the first plurality of segments 206a,d of electroluminescent material and the second plurality of segments 206c,e of electroluminescent material can be illuminated independently of each other, giving the EL-wire 200 a non-uniform illumination. For example, one of the pluralities of segments can be illuminated and another of the pluralities of segments can be unlit (or dimmed), giving the EL-wire a “checkerboard” appearance.

Although FIG. 2 is described by way of example as having two pluralities of electroluminescent segments 206a,d and 206c,e and two corresponding power conductors 208a,b, a larger number of independently operable power conductors can be included in the EL-wire 200. Each of the independently operable power conductors can correspond to a respective plurality of segments of the electroluminescent layer 206, allowing each of a variety of regions of the EL-wire 200 to be illuminated independently of other regions of the EL-wire. Periodically (or intermittently) powering the independently operable power conductors in sequence can periodically (or intermittently) illuminate the respective pluralities of segments in sequence, giving the impression that light is travelling or flowing longitudinally of (sometimes referred to as “walking along”) the EL-wire 200.

Other configurations of a segmented electroluminescent material are possible. For example, the electroluminescent layer 206 can have two segments that extend longitudinally of the core 202 along substantially the core's entire length (e.g., the recesses 205a would be eliminated and the segments 206b, 206d and 206e would be adjoining) Such continuous, longitudinally extending segments can be circumferentially spaced apart (e.g., separated by opposing longitudinally extending recesses 205b). Rather than forming a helical coil as shown in FIG. 2, the conductors 208a,b can extend longitudinally of and generally parallel to the core 202, as with the conductors 108a,b shown in FIG. 1, such that each conductor 208a,b corresponds to a respective longitudinally extending segment and is isolated from the other, circumferentially spaced apart segment(s). With such a configuration, each of the longitudinally extending segments can be illuminated independently of each other (e.g., at respective unique frequencies, at respective out-of-phase frequencies) or simultaneously with each other. As well, the longitudinally extending segments can be configured to emit light differently from each other (e.g., by having different phosphor compositions), giving the EL-wire one appearance when viewed from one direction and another appearance when viewed from another direction.

The core 202, the segmented electroluminescent material 206 and the helically coiled power conductors 208a,b can be substituted for the core 102, electroluminescent material 106 and power conductors 108a,b shown in FIG. 1, respectively, to form an EL-cable having independently illuminable segments and similar current or signal carrying characteristics as the EL-cable 100. For example, as with the EL-cable 100, an EL-cable having independently illuminable segments can be configured to operatively couple an electrical device to another electrical device (e.g., a peripheral device to a primary device).

### Electroluminescent Peripheral Cables

An EL-cable can provide a peripheral cable with an aesthetic quality that unattainable with conventional peripheral cables.

As used herein, “peripheral cable” means a cable configured to operatively couple two or more electrical devices to each other. In some instances, each of the electrical devices is an independently operable electrical device (e.g., a computing device, a television, a mobile or handheld computing device, a camera, a printer, a media device). In other instances, at least one of the electrical devices is a peripheral device that relies on a primary device to operate (e.g., a passive audio speaker, a passive microphone, a wired remote control, such as for controlling an automated massaging chair).

An electroluminescent peripheral cable can provide an aesthetically pleasing appearance and/or a plurality of visual cues as to the state of a selected condition. With such an EL-cable, a respective visual cue can be provided to correspond to each of a plurality of predetermined sensed conditions. Additionally, an EL-cable 200 having independently illuminable segments can provide a larger number of visual cues that each corresponds to a given condition.

For example, a controller (not shown) can vary an AC voltage potential applied between one of the power conductors 208a and the core 202 causing one or more qualities of the luminescent region of the EL-wire to vary in a corresponding fashion. The AC voltage potential can be selected to correspond to a predetermined sensed condition. The controller can vary another AC voltage potential applied between another of the power conductors 208b and the core 202, and the other AC voltage can be selected to correspond to another predetermined sensed condition. With such an arrangement, one or more qualities of light emitted by (and thus the appearance of) the EL-wire can correspond to one or more sensed conditions, providing a visual cue to a user as to a state of the sensed condition.

An example of a sensed condition is a frequency of a time-varying electrical signal passing through a utility conductor (e.g., conductor 110a in FIG. 1) or a magnitude of a DC current passing through the utility conductor. In connection with charging a battery, the magnitude of an electrical current supplied to the battery can correspond to an activity level of a battery charger (and/or, in some instances, a degree of the battery's charge). Accordingly, as but one example, an illumination state of the EL-cable can provide a visual cue to a user as to a condition of a battery or its charger.

Other possible visual cues include periodically varying an intensity of illumination (e.g., a gradual dimming and brightening, a rapid blinking, a “walking along”) of the EL-cable in response to a respective condition. Such conditions include, for example, an incoming call on a mobile phone, a tempo, rhythm or sound intensity of an audio signal, a data transfer between electrical devices, an absence of a signal or an electrical connection with a utility conductor, a “fault” in a computer system, a temperature of an electronic component, and any of a variety of other known and hereafter discovered conditions.

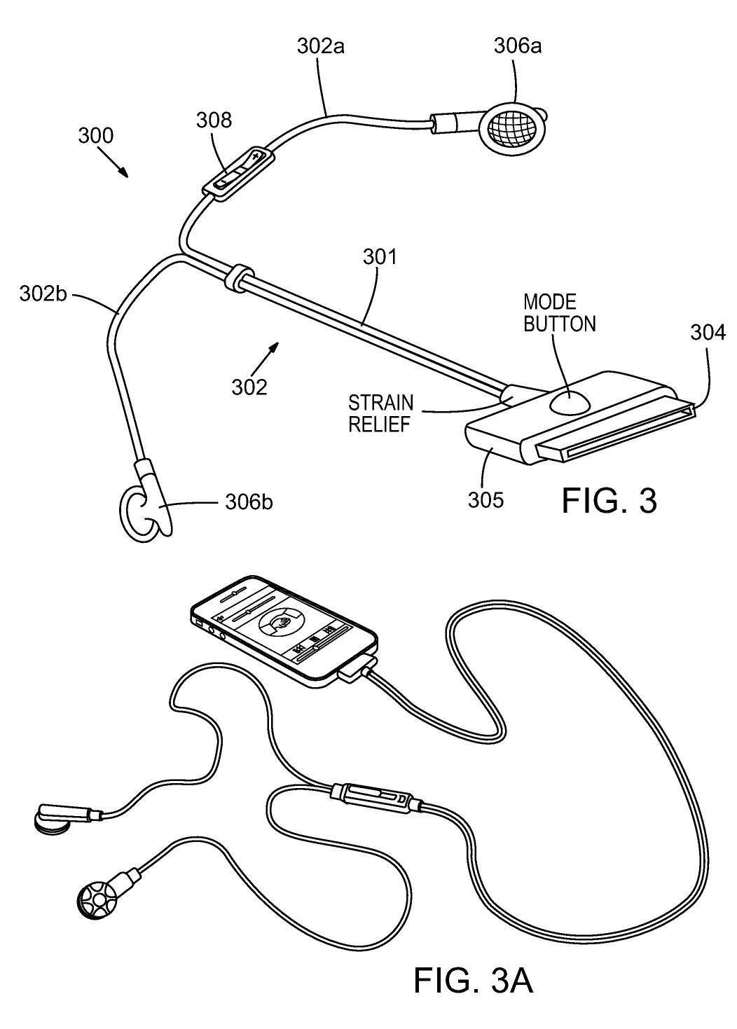

Several examples of electroluminescent peripheral cables are now described by way of reference to FIGS. 3. 4, 5, 6, 7 and 8 to illustrate several innovative principles that can be adapted to other embodiments of peripheral cables not presently described.

In FIG. 3, headphones 300 having a parasitic EL-cable 302 are shown. As with a conventional headphones, the headphones 300 have a cable 302 extending between a connector 304 and respective ear buds 306a,b. An example of such headphones operably coupled with a presently available smartphone (i.e., an iPhone® brand smartphone commercially available from Applie, Inc. of Cupertino, Calif.) is shown in FIG. 3A.

Unlike conventional headphones, however, the cable 302 is an EL-cable having a configuration similar to the EL-cable 100 (shown in FIG. 1, or as modified to include the EL-wire 200 described above in relation to FIG. 2). One or more utility wires (e.g., wires 110a-e (FIG. 1)) electrically couple individual connector pins in the connector 304 and the ear buds 302a,b in a known fashion. In some instances, the headphones 300 include a volume control and/or a microphone 308, and one or more utility wires electrically couple the volume control and/or microphone to the ear buds 302a,b and connector 304 in a known fashion.

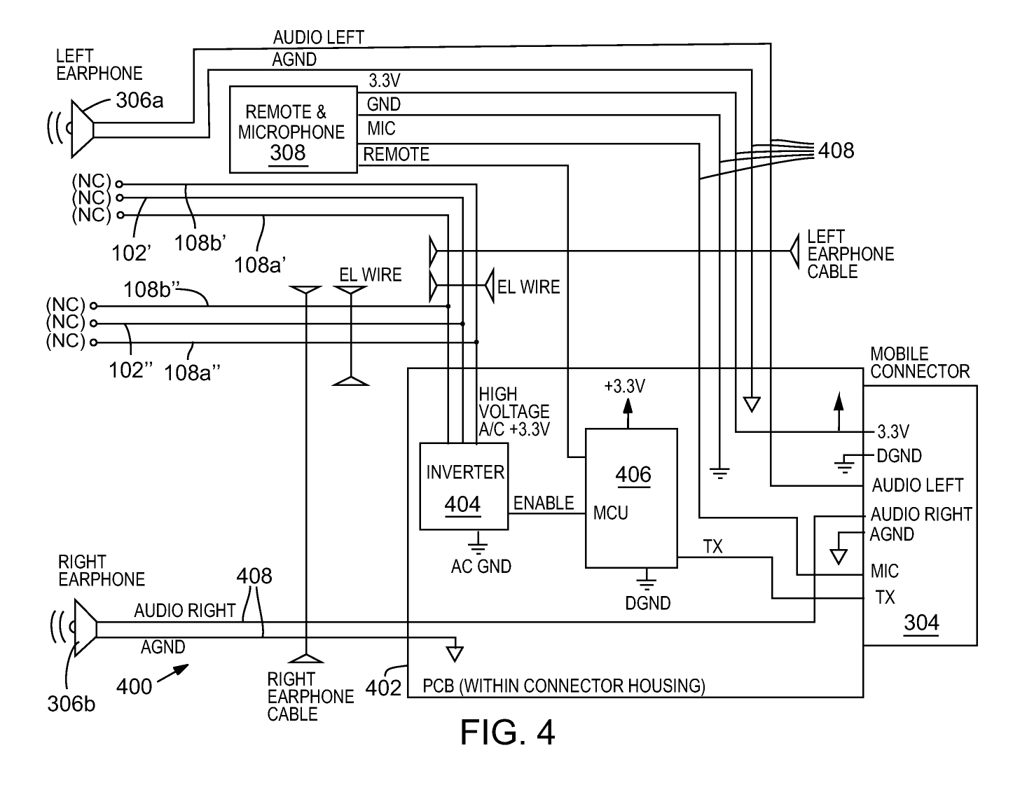

As described more fully below in connection with FIG. 4, the luminescent portion of the cable 302 (e.g., the core 102, 202, the electroluminescent material 106, 206, and the power conductors 108a,b, 208a,b, shown in FIGS. 1 and 2, respectively) can receive power through the connector 304 from an electrical device (not shown) to which the connector 304 matingly engages. As indicated above, the luminescent portion of the cable 302 can be illuminated to provide the headphone with an aesthetically pleasing appearance, to give a user a visual cue as to the state of a sensed condition (e.g., an approximate charge remaining in the external device's battery, or both).

The headphones 300 can include a housing 305. The luminescent portion of the cable 302 includes the first segment 301 of the cable extending from the housing 305, as well as the independently movable earbud extensions 302a and 302b extending between the first segment 301 and the respective earbuds 306a,b.

A substrate 402 (FIG. 4), for example a printed-circuit board (PCB), can have one or more control circuits and/or power delivery circuits (e.g., a DC-to-AC power inverter, or other power delivery circuitry). The substrate can be housed within the housing 305 and electrically couple the conductors 110a-e, 108a,b, 208a,b, 102 and 202 (FIGS. 1 and 2) to one or more respective electrical couplers (e.g., connector pads) in the connector 304. In some instances, the connector is integrally mounted in or to the housing 305, in other instances, the connector extends from the housing and in still other instances, the connector is spaced from the housing.

FIG. 4 schematically illustrates but one possible embodiment of electrical circuitry configured to operate the headphones 300, and power an electroluminescent portion of the cable 302 in a parasitic fashion from a power source of another electrical device (not shown). For example, a power inverter 404 is configured to apply an AC voltage potential between the electrical conductors 108a,b and the core 102 (FIGS. 1 and 4) from a DC power source. In the illustrated example, the DC power source is external of the headphones 300, and the inverter 404 is electrically coupleable with the external DC power source through one or more conductive pads of the connector 304. A microcontroller 406 (e.g., a microprocessor, or an application-specific integrated circuit, or ASIC) is operatively coupled with the inverter 404 to activate or deactivate the inverter, and/or to control (e.g., modulate) one or both of a frequency and a duty cycle of the inverter's output.

Utility conductors 408 (e.g., conductors 110a-e shown in FIG. 1) operatively couple the earbuds 306a,b and remote/microphone 308 to circuitry of the external electrical device through one or more respective conductive pads of the connector 304. The remote/microphone 308 can be used to control operation of the electrical device (e.g., in the case of a media player, to control earbud volume, track forward, track backward, answer an incoming telephone call, terminate a telephone call, transmit a signal representing sounds to the electrical device). The microcontroller 406 can, for example, monitor one or more operating conditions of the utility conductors, and, in response to any of a variety of selected conditions, activate, deactive or control an output of the inverter 404, thereby causing the headphones to emit light in a desired fashion responsively to the one or more sensed, e.g., operating conditions.

As well, the headphones 300 can incorporate one or more of the noise suppression, mitigation or cancellation approaches described more fully below. For example, the substrate 402 can include split ground planes and/or the microcontroller 406 (or another device) can incorporate any of the filtering techniques described below. Also presently contemplated is providing an alternative headphone design using a previously proposed EL-wire in combination with a conventional conductor for carrying an audio signal to the earbuds, and incorporating split ground planes and/or any of the filtering techniques described more fully below.

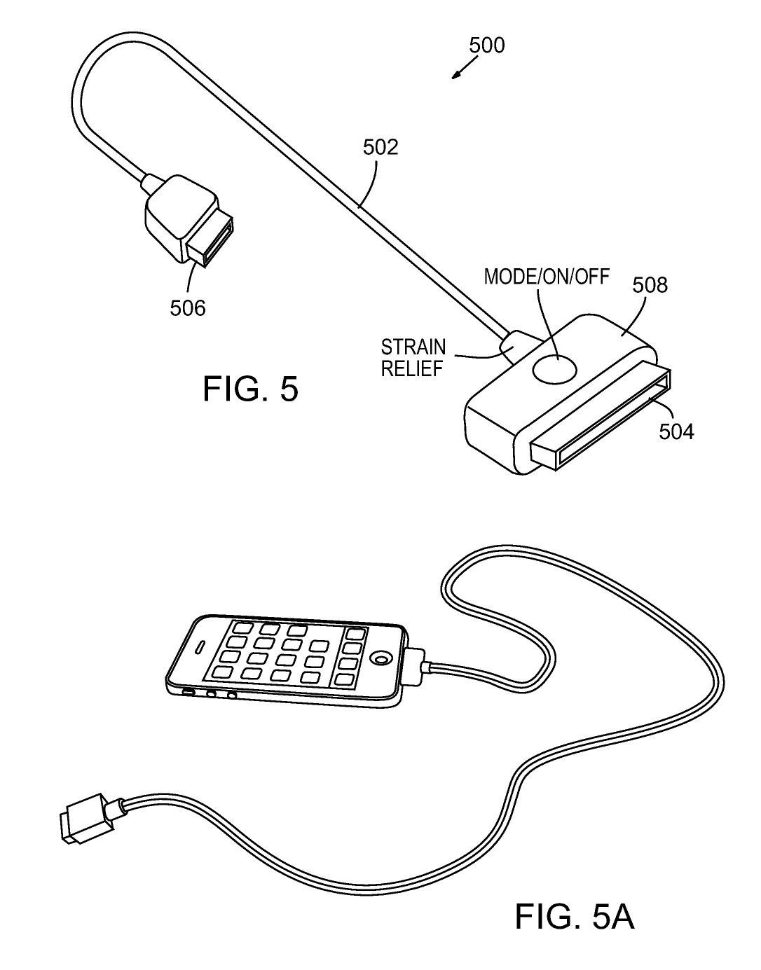

FIG. 5 illustrates another embodiment of an innovative peripheral EL-cable 500. The EL-cable 500 has a luminescent segment 502 extending between opposed electrical connectors 504 and 506. The connector 504 is operatively associated with the housing 508. The electroluminescent segment 502 can have a construction similar to the EL-cables described above by way of reference to FIGS. 1 and 2. The housing 508 can include power delivery and/or signaling circuitry similar to that described above in connection with the headphones 300 and with reference to FIG. 4 (e.g., for reducing or eliminating noise in a signal carried by a utility conductor). Although the illustrated embodiment of the peripheral cable 500 includes a conventional 30-pin connector 504 and a conventional USB connector 506, any combination of now known or hereafter developed electrical and/or hybrid electrical/optical connectors can be incorporated in the cable 500 (such as, for example, a micro-USB connector).

In the cable 500, the utility conductors 110a-e can be configured to convey analog or digital signals, and/or electrical power, between respective conductors in the connectors 504 and 506. In addition, an illumination state of the EL-cable 502 can be selected to provide a user with a visual cue of one or more respective sensed conditions (e.g., a degree of battery charge in a mobile phone). FIG. 5A shows an example of the cable 500 connected to a presently available smartphone of the type shown in FIG. 3A.

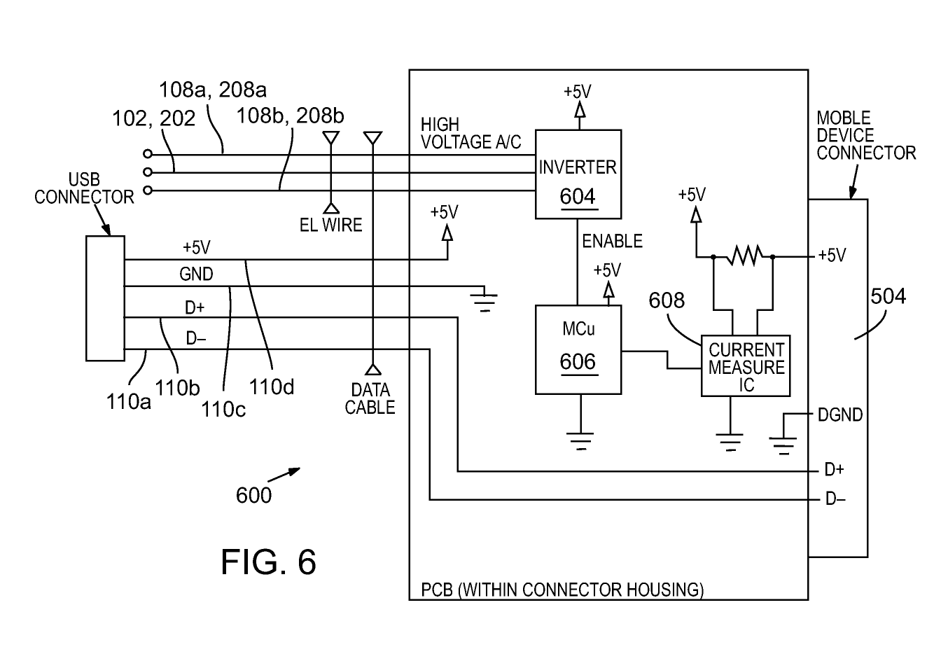

FIG. 6 illustrates a block diagram of an example of circuitry 600 that can be housed in the housing 504. As with the circuitry 400 shown in FIG. 4, the circuitry 600 can include a power inverter 604 for powering the electroluminescent portion of the EL-cable 502 and a microcontroller 606 configured to control operation of the power inverter 604. The circuitry 600 is also shown as including a sensor 608 operatively coupled with the microcontroller 606. The sensor 608 can be configured to sense any of a variety of conditions, and in the illustrated example, the sensor 608 is configured as a current measurement device. Measuring current carried by a conductor operatively coupling an external power source (e.g., of a computer, or power supply) to a battery of another device (e.g., a mobile media device, or a cell phone) can provide an indication of the degree of charge that the battery has attained. In the illustrated embodiment, the microcontroller 606 is configured to control an output of the inverter 604 to provide a user with a visual cue when a measured current drops below a selected threshold current, indicating that the battery has attained a selected degree of charging. As but one example, the EL-cable 502 can be configured to dim when the battery has attained an 80% charge, and can be made to periodically brighten and dim when the battery has attained a 95% charge.

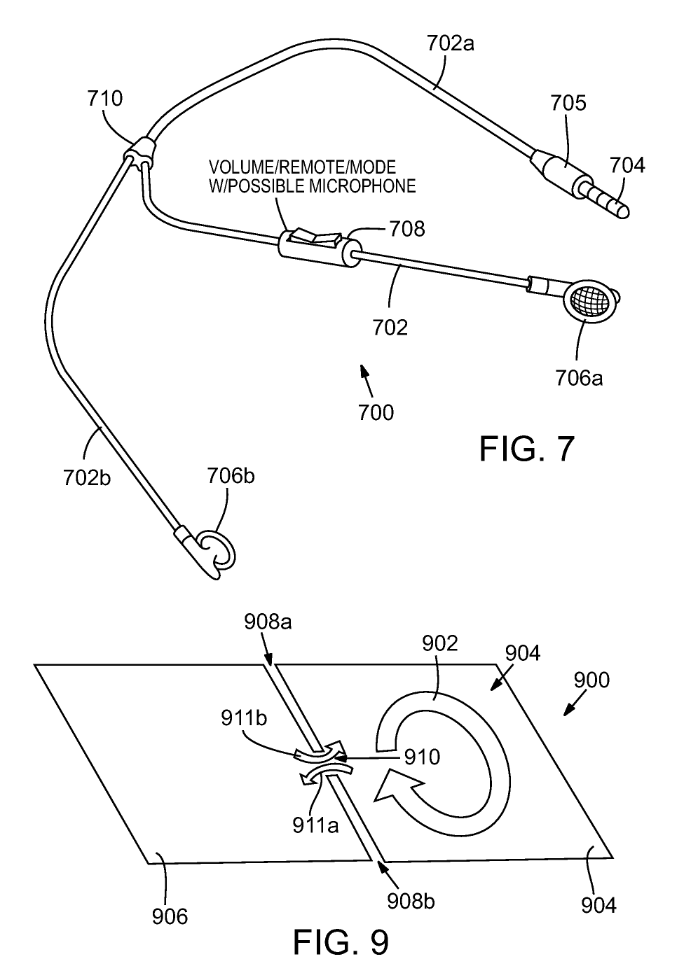

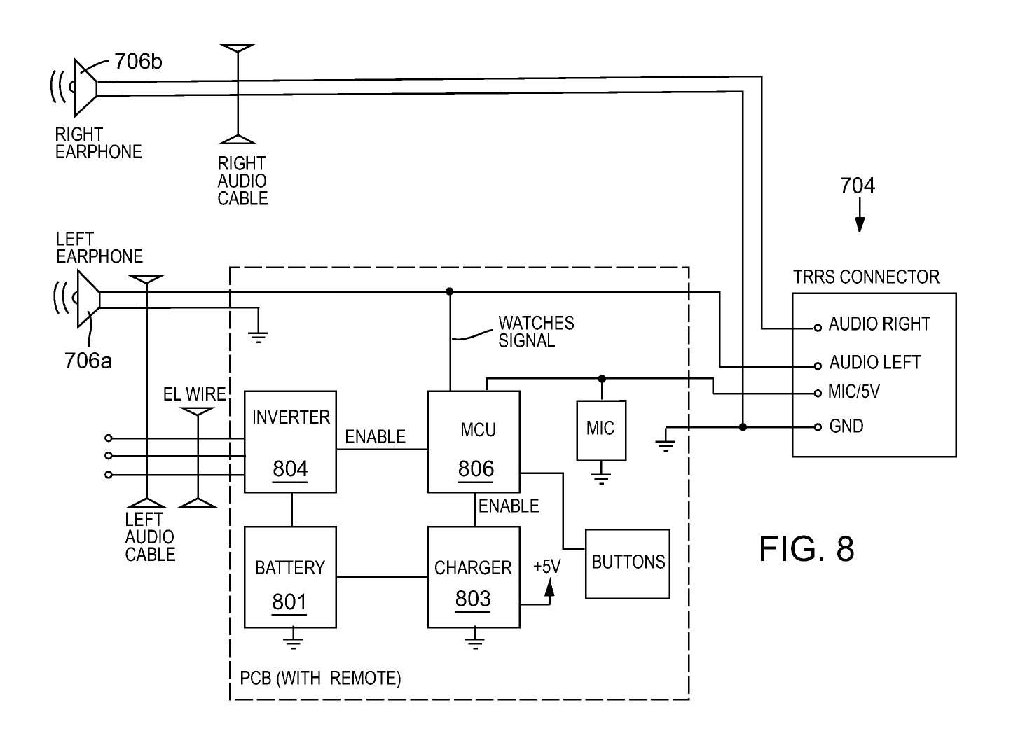

FIG. 7 shows another embodiment of an electroluminescent headphone. The headphone 700 is similar in construction to the headphone 300 shown in FIG. 3, having a connector 704 configured to operatively couple the earbuds 706a, 706b to an audio signal source in an external device (not shown), as well as a remote/microphone 708. Unlike the headphone 300, the headphone 700 includes a battery for powering the EL-wire portion of the cable 702, 702a, 702b. The battery 801 (FIG. 8) can be any known or hereafter developed battery, including, for example, a non-rechargeable alkaline battery or a rechargeable lithium-based battery. The battery 801 (FIG. 8) can be housed in a housing 705 adjacent the connector 704, a splitter housing 710 from which the cable portions 702a,b extend, and/or in the housing of the remote/microphone 708.

An advantage of the headphone 700 is that audio signals from, for example, a mobile media device, can be controlled from the external device (not shown) in a known fashion. In addition, depletion of the external device's power supply (often a battery) is reduced since the battery 801 is used to power the luminescent portions of the cable 702, 702a,b, rather than the external device's battery, as with parasitic peripheral cables, which can allow a longer, continuous use of the external device than otherwise might be possible when using a parasitic headphone. As well, the headphones 700 can be less susceptible to noise in the audio signal, since the inverter receives power from the battery, independently of the power source of the external device that transmits the audio signals.

As indicated in FIG. 8, the circuitry for the headphones 700 can include a charger 803, allowing the battery 801 to be selectively recharged. In some instances, the battery can be recharged by matingly engaging the TRRS connector 704 to an external power source (e.g., a charger) configured to supply a sufficient current to one of the conductive elements of the connector.

As with the circuitry shown in FIG. 6, the circuitry shown in FIG. 8 can include a microcontroller 806 operatively coupled to an inverter 804, and the microcontroller can monitor a signal in one or more utility conductors 100a-e (FIG. 1). For example, the microcontroller 806 can monitor one of the signal conductors (e.g., coupled to the left earbud 706a) and activate the inverter 804 in response to the presence of an audio signal and deactivate the inverter in response to the absence of an audio signal.

In some instances, the microcontroller 806 can detect the presence of, for example, a +5V DC power source, as when the TRRS connector 704 is matingly engaged with a charger. When the power source is detected, the microcontroller 806 can activate the charger 803. As but one example, an embodiment of the peripheral cable 500 (FIG. 5) can include a TRRS socket configured to provide a +5V DC (or other operating voltage) current source for charging rechargeable devices, including the battery 801 in the headphone 700.

### Noise Suppression

As noted above, the luminescent portion of an EL-wire or an EL-cable is typically powered by a high voltage AC power source. A selected operating frequency can correspond to one or more properties of the selected electroluminescent material (e.g., a weight-percent of phosphor, a material thickness). In general: increasing one or both of a voltage and a frequency results in relatively brighter illumination of the luminescent region, and a relatively shorter operating life. In some instances, power is supplied at about 180 V AC (e.g., between about 170 V AC and about 190 V AC), with frequencies ranging from about 0 Hz to about 4 KHz. On the other hand, many commercially available electrical devices (e.g., an iPod® media player, a Zune® media player, an Android® smart phone) operate from a regulated about 3.3 V DC power supply. For example, many phones and media players are powered by a lithium-based battery that delivers a DC voltage from about 4.3 V to about 2.7V, depending on the battery's charge level. Internal voltage regulation circuitry can “switch” the supplied battery voltage to a selected operating voltage, with a common selected operating voltages being about 3.3 V. Accordingly, many devices provide an approximately 3.3V DC power pad in an expansion or dock connector for powering a peripheral device. Another common voltage used in commercially available electrical devices is 5 V DC. In any event, an electrical current from an available DC power supply can be converted, for example, to 180 V AC, enabling the available DC power supply to be used to supply power to the luminescent portion of an EL-wire or an EL-cable.

Unfortunately, however, electromagnetic radiation is typically emitted by the current-carrying conductors (e.g., the core 102 and conductors 108a,b shown in FIG. 1) of the luminescent portion of an EL-cable. A field of electromagnetic radiation can introduce noise in a nearby signal on a nearby conductor (e.g., the wires 110a-e in FIG. 1). Such noise is sometimes referred to as electromagnetic interference, or “EMI.”

A magnitude of signal noise induced by EMI can be reduced by using appropriate shielding. For example, referring to FIG. 1, the sheath 112 can be grounded, which would tend to shield the signal wires 110a-e from EMI emitted by the power conductors 108a,b.

Another source of noise comes from electrical currents on a ground plane, particularly a ground plane shared by a power supply and one or more signal conductors. As described above in connection with examples of peripheral EL-cables, particularly parasitic EL-cables, a power supply in an external device can be used to supply power to one or more luminescent portions of the cable. As well, one or more signal conductors (e.g., wires 110a-e in FIG. 1) can carry a signal transmitted by the external device. In this common instance, the signals and the power supply can share a ground plane, and the relatively high current draw of the luminescent portion of the EL-cable can induce an electric current across the ground plane (e.g., as indicated by the broad arrow 902 shown in FIG. 9).

FIG. 9 shows an example of a split ground plane 900 configured to reduce the ability of an electrical current 902 to flow from a first region 904 of the shared ground plane to a second region 906 of the shared ground plane. In the illustrated example, the ground plane 900 defines opposed notches 908a,b, spacing most of the first region 904 of the ground plane from most of the second region 906 of the ground plane. However, the opposed notches 908a,b do not entirely bisect the ground plane 900, instead leaving a narrow strip of electrical conductor 910 (sometimes referred to as a “bridge”) spanning the gap 908a,b between the first region 904 and the second region 906. The bridge 910 allows small currents 911a,b to flow between the regions 904, 906, but generally reduces their magnitude.

Consequently, ground-plane currents 902 induced by a power supply grounded to, for example, the first region 904 are generally contained in the first region and do not pass to the second region 906. Accordingly, a signal circuit grounded to, for example, the second region 906 can generally operate with a reduced degree of interference, or noise, that otherwise would arise from the ground-plane currents 902 in the absence of the opposed notches 908a,b.

The amount noise in a signal (e.g., in an analog audio signal) can be reduced by appropriately shielding the signal conductors (e.g., to mitigate EMI induced noise) and by splitting the ground plane (e.g., to mitigate the effects of fluctuations in current drawn by the power supply), as just described. Despite such noise reduction, noise in a signal can still arise, reducing a quality of the signal. For example, a “humming” tone can be introduced into an audio signal carried by an EL-cable, despite using split ground planes and shielding positioned between the signal wires 110a-e and the power conductors 108a,b (FIG. 1).

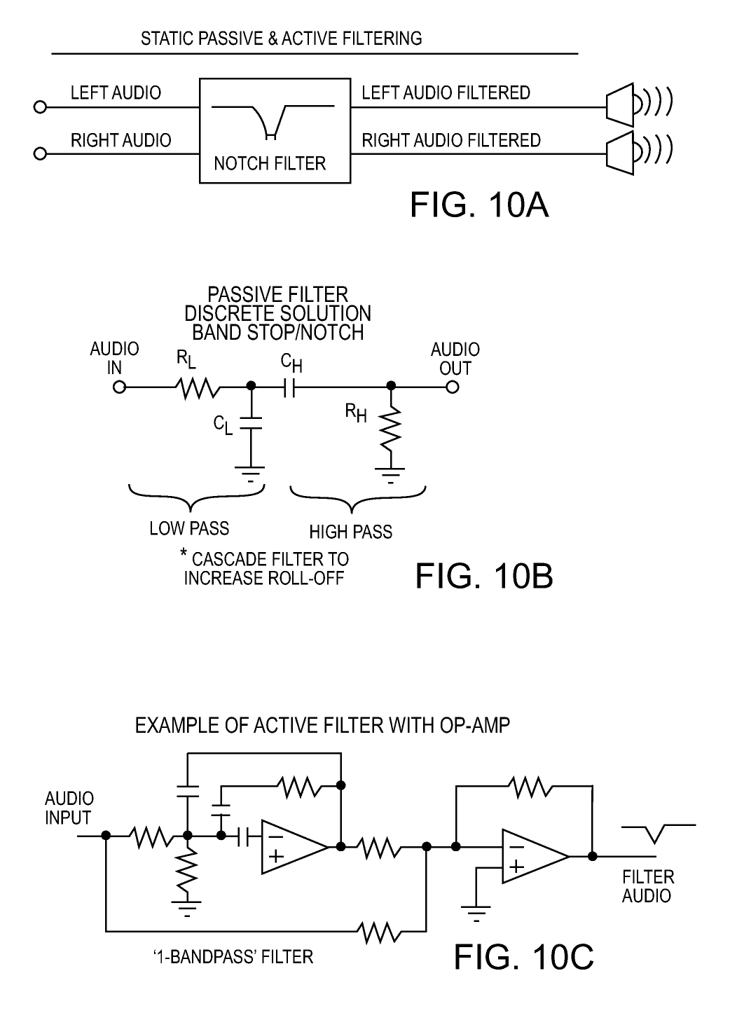

Some EL-cables include a signal conditioning circuit configured to suppress such residual signal noise. FIG. 10A through FIG. 13 schematically illustrate several such noise-suppression circuits that can be incorporated in any one or more of the EL-cables described herein.

For example, a suspected noisy signal can pass through a static filter configured to eliminate one or more selected frequency bands from the signal. Such a filter is sometimes referred to as a “notch filter”. FIG. 10A schematically illustrates such a signal conditioner. FIG. 10B illustrates a passive filter circuit that can be used to filter, for example, an audio signal. FIG. 10C illustrates an active filter based on an op-amp. Regardless of whether an active or passive static filter is used, the characteristics (e.g., specific frequency bands, whether the bands drift with changes in temperature) of the noise should be known before building the filter, since the filter will filter one or more selected (but fixed) bands from the signal.

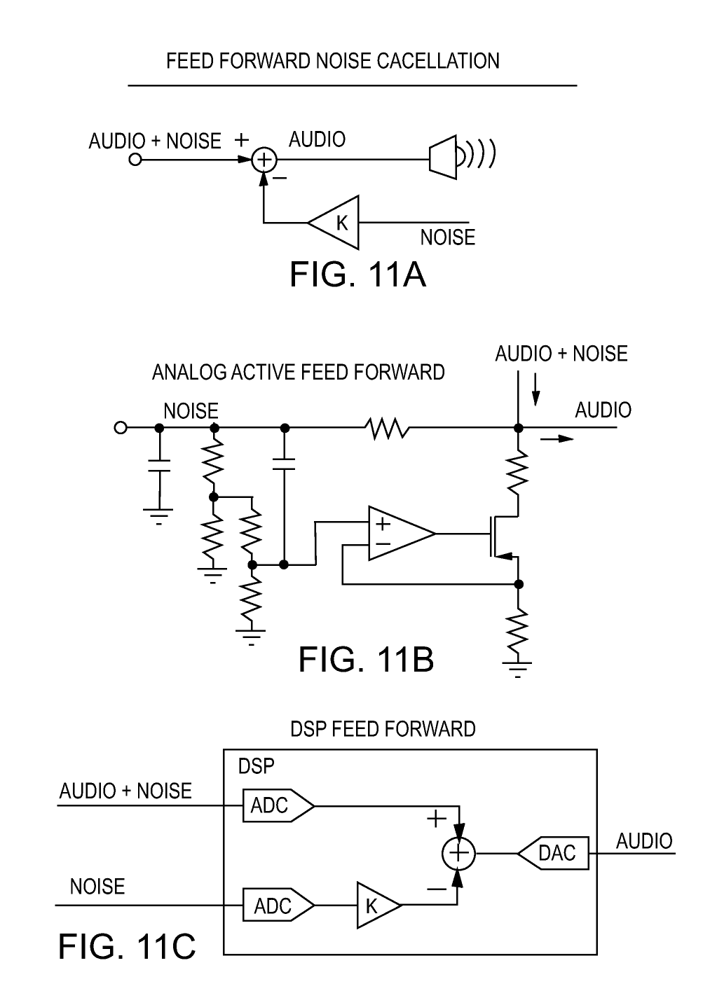

FIGS. 11A-11C schematically illustrate signal conditioners based on feed forward noise cancellation. It is believed that the likely noise source is the power supply (e.g., in connection with parasitic peripheral EL-cables). In feed-forward noise cancellation, a gained representation of the power supply noise is subtracted from the signal (e.g., an analog audio signal). It is believed that this approach can be well-suited for peripheral EL-cables, since a major portion of signal noise is expected to arise from the power supply. Nonetheless, a unique gain may be selected for each and every instance of a product, since the required gain can vary as a result of manufacturing tolerances of components. The signal conditions shown in FIGS. 11A-11C can be implemented using discrete component circuits, as well as a digital signal processor.

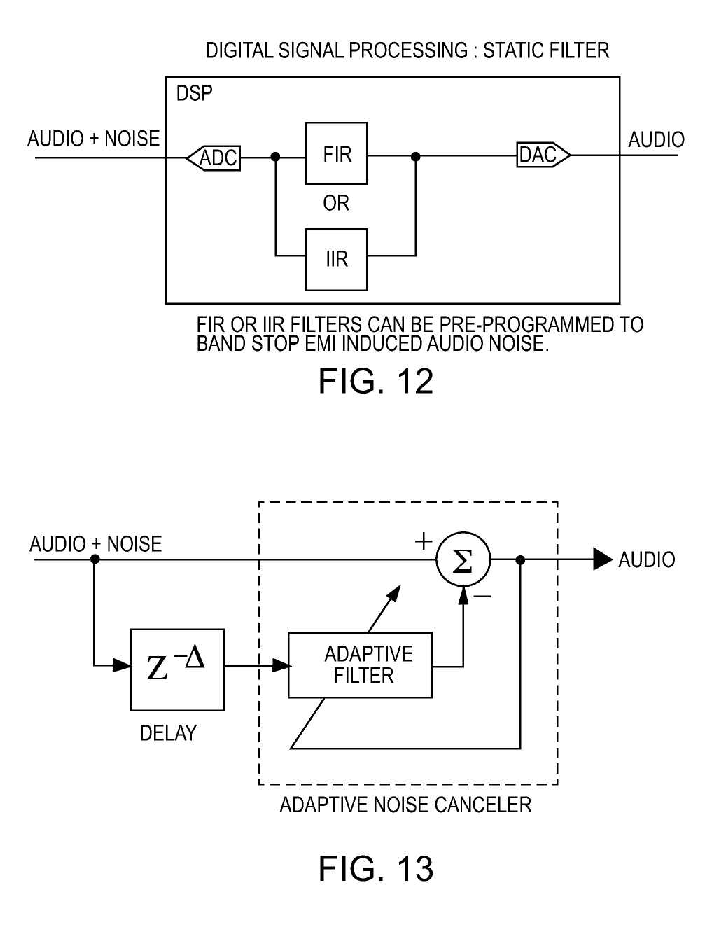

FIG. 12 illustrates a static filter with a digital signal processor. Either an Infinite Impulse Response (IIR) or Finite Impulse Response (FIR) filter can be convolved with an incoming, e.g., audio, signal to filter the noise. This approach also typically requires the characteristics of the filter to be pre-defined, as with the notch filter shown in FIGS. 10A-10C.

Nonetheless, the DSP can “learn” the character of a given noise by, for example, monitoring signal noise in the absence of a signal (e.g., in the absence of an analog audio signal). The noise can be recorded and a filter can be generated (e.g., using a Fourier transformation technique) from the recorded noise. Such an approach would typically require a microprocessor with some level of computational capacity, and may add cost, but the approach can eliminate many of the specific tuning limitations discussed above in connection with the discrete component filters.

FIG. 13 shows yet another filter approach based on adaptive filtering. An adaptive filter generally does not need any prior knowledge of a noise input. Instead, the adaptive filter “listens” to (e.g., monitors) the input signal (which includes noise) and concurrently builds a filter based on observed, periodic signals, assumed to be “noise” that should be filtered, and filters the signal based on the observed periodic signals. Such an approach typically requires a microprocessor having a relatively larger degree of computational capability than the other filtering techniques.

### Other Embodiments

Although the illustrated peripheral cables and associated circuitry shown in the accompanying drawings and described above are believed to be configured for compatibility with a typical 30-pin connector available on iPod® or iPad® products commercially available from Apple, Inc. of Cupertino, Calif., the principles described herein can be applied to any of a variety of peripheral cables being compatible with other media and/or computing devices and, more broadly, other electrical devices, generally.

This disclosure makes reference to the accompanying drawings which form a part hereof, wherein like numerals designate like parts throughout. The drawings illustrate specific embodiments, but other embodiments may be formed and structural changes may be made without departing from the intended scope of this disclosure. Directions and references (e.g., up, down, top, bottom, left, right, rearward, forward, etc.) may be used to facilitate discussion of the drawings but are not intended to be limiting. For example, certain terms may be used such as “up,” “down,”, “upper,” “lower,” “horizontal,” “vertical,” “left,” “right,” and the like. These terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” surface can become a “lower” surface simply by turning the object over. Nevertheless, it is still the same surface and the object remains the same. As used herein, “and/or” means “and” as well as “and” and “or.”

Accordingly, this detailed description shall not be construed in a limiting sense, and following a review of this disclosure, those of ordinary skill in the art will appreciate the wide variety of imaging electroluminescent devices and filtering methods that can be devised and built using the various concepts described herein. Moreover, those of ordinary skill in the art will appreciate that the exemplary embodiments disclosed herein can be adapted to various configurations without departing from the disclosed concepts. Thus, in view of the many possible embodiments to which the disclosed principles can be applied, it should be recognized that the above-described embodiments are only examples and should not be taken as limiting in scope. We therefore claim as our invention all that comes within the scope and spirit of the following claims.

All patent and non-patent literature cited herein is hereby incorporated by references in its entirety for all purposes.

What is currently claimed:

1. A luminescent cable defining a central axis extending longitudinally of the cable, the cable comprising:
an electrically conductive core defining a longitudinal axis being substantially coextensive with the central axis of the cable and having an outwardly facing outer surface;
an electroluminescent material electrically coupled to a portion of the outer surface of the core;
a first electrical conductor outwardly spaced from the core and electrically coupled to the electroluminescent material such that an AC-voltage potential applied between the core and the first electrical conductor induces the electroluminescent material to luminesce, thereby defining a luminescent region of the cable;
a second electrical conductor outwardly spaced from and helically overlying the core, and substantially electrically isolated from the electroluminescent material; and
an insulation layer overlying the second electrical conductor and at least a portion of the luminescent region of the cable.

2. The cable of claim 1, further comprising an electromagnetic shielding member positioned between the second electrical conductor and the first electrical conductor.

3. The cable of claim 1, further comprising a power circuit configured to apply an AC voltage potential between the first electrical conductor and the core from a DC power source.

4. The cable of claim 3, further comprising a noise suppression circuit configured to suppress noise within a data signal carried by the second electrical conductor, wherein the noise is caused, at least in part, by the AC voltage potential between the first electrical conductor and the core

5. The cable of claim 4, wherein the noise suppression circuit comprises an electro-magnetic interference suppression circuit.

6. The cable of claim 5, wherein the electro-magnetic interference suppression circuit comprises a grounded shielding member positioned between the second electrical conductor and one or more of the electroluminescent material, the first electrical conductor, and the core.

7. The cable of claim 5, wherein the electro-magnetic interference suppression circuit comprises a split ground plane defining a first grounding region and a second grounding region, wherein the power circuit is grounded to the first grounding region and the second electrical conductor is grounded to the second grounding region.

8. The cable of claim 4, wherein the noise suppression circuit comprises a signal conditioning circuit configured to condition a signal carried by the second electrical conductor.

9. The cable of claim 8, wherein the signal conditioning circuit comprises one or more of a static passive filter, a static active filter, a feed forward filter, a digital signal processor, a dynamic filter, and an adaptive filter.

10. The cable of claim 1, further comprising at least a third electrical conductor, wherein the second electrical conductor and the third electrical conductor comprise utility conductors.

11. The luminescent cable of claim 1, wherein the second electrical conductor comprises a utility conductor configured to operatively couple a peripheral device to an electrical device.

12. The luminescent cable of claim 11, wherein the peripheral device comprises one or more of an audio speaker, a microphone, a battery, a computing device, a media device, a mobile device, a printer, an extension cord, a data cable, a USB connector, a micro-USB connector, a stereo audio cable, a car charger, decorative lights, and an antenna.

13. The luminescent cable of claim 12, further comprising a controller configured to control a frequency of the AC voltage potential applied between the core and the first electrical conductor responsively to a sensed condition of the utility conductor.

14. The luminescent cable of claim 13, wherein the sensed condition comprises one or both of a frequency of a time-varying electrical signal passing through the utility conductor and an amplitude of a time-varying electrical signal passing through the utility conductor, wherein the time-varying electrical signal comprises one or both of a time-varying voltage and a time-varying current.

15. A luminescent cable, comprising:
an electrically conductive core defining an outwardly facing outer surface;
a segmented electroluminescent material electrically coupled to a portion of the outer surface of the core;
a first electrical conductor outwardly spaced from the core and electrically coupled to a first plurality of segments of the electroluminescent material such that an AC-voltage potential applied between the core and the first electrical conductor induces the first plurality of segments of the electroluminescent material to luminesce, thereby defining a first luminescent region of the cable.

16. The cable of claim 15, further comprising a second electrical conductor outwardly spaced from the core and electrically coupled to a second plurality of segments of the electroluminescent material such that an AC-voltage potential applied between the core and the second electrical conductor induces the second plurality of segments of the electroluminescent material to luminesce, thereby defining a second luminescent region of the cable.

17. The luminescent cable of claim 16, wherein the first electrical conductor is sufficiently electrically isolated from the second plurality of segments of the electroluminescent material that an AC voltage potential applied between the core and the first electrical conductor does not induce the second plurality of segments of the electroluminescent material to luminesce.

18. The luminescent cable of claim 16, wherein the second electrical conductor is sufficiently electrically isolated from the first plurality of segments of the electroluminescent material that an AC voltage potential applied between the core and the second electrical conductor does not induce the first plurality of segments of the electroluminescent material to luminesce.

19. The luminescent cable of claim 17, wherein the second electrical conductor is sufficiently electrically isolated from the first plurality of segments of the electroluminescent material that an AC voltage potential applied between the core and the second electrical conductor does not induce the first plurality of segments of the electroluminescent material to luminesce.

20. The luminescent cable of claim 19, wherein, when a frequency of the AC voltage potential applied between the core and the first electrical conductor is out of phase with a frequency of the AC voltage potential applied between the core and the second electrical conductor, the first plurality of segments of the electroluminescent material and the second plurality of segments of the electroluminescent material to luminesce at respective out-of-phase frequencies.

21. The luminescent cable of claim 16, wherein the cable is configured such that the first plurality of segments and the second plurality of segments are capable of luminescing at respective out-of-phase frequencies.

22. The luminescent cable of claim 16, further comprising a utility conductor configured to operatively couple a peripheral device to an electrical device.

23. The luminescent cable of claim 22, wherein the peripheral device comprises one or more of an audio speaker, a microphone, a battery, a computing device, a media device, a mobile device, a printer, an extension cord, a data cable, a USB connector, a micro-USB connector, a stereo audio cable, a car charger, decorative lights, and an antenna.

24. The luminescent cable of claim 20, further comprising a utility conductor configured to operatively couple a peripheral device to an electrical device, wherein one or both of the frequency of the AC voltage potential applied between the core and the first electrical conductor and the frequency of the AC voltage potential applied between the core and the second electrical conductor corresponds to a sensed condition of the utility conductor.

25. The luminescent cable of claim 24, wherein the sensed condition comprises one or both of a frequency of a time-varying electrical signal passing through the utility conductor and an amplitude of a time-varying electrical signal passing through the utility conductor, wherein the time-varying electrical signal comprises one or both of a time-varying voltage and a time-varying current.

26. A luminescent apparatus, comprising:
an electroluminescent wire configured to luminesce in response to an AC voltage potential applied to the electroluminescent wire;
a signal conductor and a ground conductor; and
a noise suppression circuit configured to suppress noise within a data signal carried by the signal conductor caused, at least in part, by an alternating current induced by the AC voltage potential.

27. The cable of claim 26, wherein the noise suppression circuit comprises an electro-magnetic interference suppression circuit.

28. The cable of claim 27, wherein the electro-magnetic interference suppression circuit comprises a grounded shielding member positioned between the second electrical conductor and one or more of the electroluminescent material, the first electrical conductor, and the core.

29. The cable of claim 27, wherein the electro-magnetic interference suppression circuit comprises a split ground plane defining a first grounding region and a second grounding region, wherein the power circuit is grounded to the first grounding region and the second electrical conductor is grounded to the second grounding region.

30. The cable of claim 26, wherein the noise suppression circuit comprises a signal conditioning circuit configured to condition a signal carried by the second electrical conductor.

31. The cable of claim 30, wherein the signal conditioning circuit comprises one or more of a static passive filter, a static active filter, a feed forward filter, a digital signal processor, a dynamic filter, and an adaptive filter.

32. An electroluminescent cable, comprising:
an electroluminescent wire having a first power conductor and a second power conductor, wherein the electroluminescent wire is configured to luminesce in response to an AC voltage applied between the first power conductor and the second power conductor;
an electrical connector having a plurality of electrical couplers, wherein the electrical connector is configured to matingly engage with a correspondingly configured electrical connector of an electrical device, and, thereby, to electrically couple at least one of the electrical couplers to a DC power circuit of the electrical device.
a housing; and
a power circuit positioned within the housing and so operatively coupled to the at least one of the electrical couplers as to be configured to receive an electrical current from the DC power circuit of the electrical device, and so operatively coupled to the first power conductor and to the second power conductor as to deliver an AC voltage potential between the first power conductor and the second power conductor based on power derived from the DC power circuit of the electrical device.

33. The electroluminescent cable of claim 32, further comprising a signal conductor electrically coupled to another of the electrical couplers, such that the signal conductor is electrically coupleable to a signaling circuit of the electrical device when the electrical connector is matingly engaged with the electrical connector of the electrical device.

34. The electroluminescent cable of claim 33, wherein the signal conductor comprises a first signal conductor, the cable further comprising a second signal conductor, wherein the first signal conductor and the second signal conductor are positioned adjacent to each other in a first segment of the cable and are spaced from each other in a second segment of the cable.

35. The electroluminescent cable of claim 34, wherein the first signal conductor and the second signal conductor are independently movable relative to each other in the second segment of the cable.

36. The electroluminescent cable of claim 35, further comprising:
a first audio speaker configured to receive a first audio signal from the first signal conductor; and
a second audio speaker configured to receive a second audio signal from the second signal conductor.

37. An electroluminescent audio cable, comprising:
an electroluminescent wire having a first power conductor and a second power conductor, wherein the electroluminescent wire is configured to luminesce in response to an AC voltage applied between the first power conductor and the second power conductor;
a first signal conductor and a second signal conductor, wherein the first signal conductor and the second signal conductor are positioned adjacent to each other in a first segment of the audio cable and wherein the first signal conductor and the second signal conductor are spaced from each other in a second segment of the audio cable;
a splitter housing positioned between the first segment of the audio cable and the second segment of the audio cable, such that the first signal conductor extends from the splitter housing in a first direction and the second signal conductor extends from the splitter housing generally in a second direction opposite the first direction; and
a power circuit positioned within the splitter housing and so operatively coupled to the first power conductor and the second power conductor as to deliver an AC voltage potential between the first power conductor and the second power conductor from a battery positioned within the splitter housing.

38. The electroluminescent cable of claim 37, wherein the second segment of the cable comprises independently movable first and second lengths of wire comprising the first conductor and the second conductor, respectively, wherein the first and the second lengths of wire generally extend from the splitter housing in a first direction, and wherein the first segment of the cable extends from the splitter housing in a direction generally opposite from the first direction.

39. The electroluminescent cable of claim 37, further comprising an electrical connector having a plurality of electrical couplers, wherein the power circuit is operatively coupled to at least one of the electrical couplers, wherein the electrical connector is configured to matingly engage with a correspondingly configured electrical connector of an electrical device, and, thereby, to electrically couple the at least one of the electrical couplers to a power supply circuit of the electrical device so as to direct a recharging current to the battery.

40. The electroluminescent cable of claim 37, further comprising an electrical connector having a plurality of electrical couplers, wherein each of the first signal conductor and the second signal conductor is operatively coupled to a respective one or more of the electrical couplers, wherein the electrical connector is configured to matingly engage with a correspondingly configured electrical connector of an electrical device, and, thereby, to electrically couple each of the respective one or more electrical couplers to a respective signaling circuit of the electrical device so as to operatively couple the first signal conductor and the second signal conductor to respective signaling circuits of the electrical device.
